(19) United States
(12) Patent Application Publication
(10) Pub. No.: US 2013/0225213 A1
(43) Pub. Date: Aug. 29, 2013

(54) SYSTEM AND METHOD FOR DIRECT MESSAGING BETWEEN MOBILE STATIONS USING PACKET-BASED COMMUNICATIONS

(71) Applicant: John ANTYPAS, III, Pittsburg, CA (US)

(72) Inventor: John ANTYPAS, III, Pittsburg, CA (US)

(73) Assignee: Cellco Partnership d/b/a Verizon Wireless, Basking Ridge, NJ (US)

(21) Appl. No.: 13/406,273

(22) Filed: Feb. 27, 2012

(51) Int. Cl. H04W 4/12

(52) U.S. Cl. 455/466

(57) ABSTRACT

Direct messaging services between mobile stations use packet-based communications. A destination mobile station having a mobile number and a packet address registers, in a network directory server, the packet address with a hostname corresponding to the mobile number. A sending mobile station, upon receiving a messaging service message for transmission to the mobile number of the destination mobile station, sends an address query to the network directory server including the hostname corresponding to the mobile number of the destination mobile station. Upon receiving from the network directory server a response to the query including the packet address for the destination mobile station, the sending mobile station transmits the messaging service message as one or more packets to the destination packet address.

### BACKGROUND

Messaging services between mobile stations rely on specialized infrastructure for operation. To send and receive short messaging service (SMS) messages to/from mobile stations, for example, a mobile network operator must maintain a short message service center (SMSC). Similarly, to provide a multimedia messaging service (MMS), an enhanced messaging service (EMS), or other type of advanced messaging service, the network operator must provide corresponding service centers and ensure that the service centers have sufficient throughput to sustain the messaging load of users of the mobile network. As messaging volumes increase, and as new types of messaging are developed, network operators are therefore faced with costs associated with expanding messaging service centers to handle the increased traffic, and with providing new service centers to support new types of messaging services.

Meanwhile, improvements in processing and communications have led to mobile stations' capabilities expanding beyond basic voice communication and text/multimedia messaging services. For example, mobile stations are now capable of packet-based communications over the Internet. Carriers typically charge for mobile messaging services, and separately charge for data plans. Some plans charge mobile station subscribers a fee per message sent and/or received, or a fee per message sent and/or received over some threshold corresponding to a flat monthly payment. The plans generally also charge mobile station subscribers a fee per kilobyte of data sent and/or received, or a fee per kilobyte sent and/or received over some threshold corresponding to a flat monthly payment. Messaging and data services thus represent sources of revenue for carriers of mobile wireless networks.

A need exists to leverage the mobile stations' improved communication capabilities, including packet-based communication capabilities, to provide new messaging or other inter-device communication capabilities for mobile stations operating on mobile networks.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a simplified block diagram showing a system for providing direct messaging between mobile stations using packet-based communication services.

FIG. 2A is a flow diagram illustratively showing a method for providing direct messaging service from a mobile station to another mobile station using packet-based communications.

FIG. 2B is a flow diagram illustratively showing a method for providing direct messaging service to a mobile station from another mobile station using packet-based communications.

FIG. 2C is a flow diagram illustratively showing a method for registering a mobile station with a network directory.

FIG. 2D is a flow diagram illustratively showing a method for converting a mobile number of a mobile station into a hostname for the mobile station.

FIG. 3 is a simplified block diagram showing software elements of a mobile station that may be used to implement the methods described herein.

FIG. 4 is a high-level functional block diagram of an example of a system of networks/devices that provide various communications for mobile stations and support an example of the direct messaging service.

FIG. 5 is a high-level functional block diagram of an exemplary mobile station as may utilize the direct messaging service through a network/system like that shown in FIGS. 1 and 4.

FIG. 6 is a simplified functional block diagram of a computer that may be configured as a host or server, for example, to function as the network directory in the system of FIGS. 1 and 4.

FIG. 7 is a simplified functional block diagram of a personal computer or other work station or terminal device.

### DETAILED DESCRIPTION

In the following detailed description, numerous specific details are set forth by way of examples in order to provide a thorough understanding of the relevant teachings. However, the present teachings may be practiced without such details. In other instances, well known methods, procedures, components, and/or circuitry have been described at a relatively high-level, without detail, in order to avoid unnecessarily obscuring aspects of the present teachings.

The various systems and methods disclosed herein relate to direct messaging between mobile stations operating in a mobile network providing packet-based communication services.

Direct mobile station to mobile-station messaging is provided by enabling a first mobile station to send a message directly to a second mobile station by sending the message to the packet address of the second mobile station. The packet address may be an IP address, and is generally assigned by the carrier of the mobile communication network to a mobile station operating on the network. To provide the direct messaging service, each mobile station registers with a network directory (e.g., a DNS server) to create an entry in the network directory associating the packet address assigned to the mobile station with a unique hostname for the mobile station. The hostname is obtained by converting the mobile station's mobile telephone number into a unique identifier for the mobile station, such that any device having the destination mobile station's telephone number can determine the destination mobile station's hostname. In one example, the hostname is obtained by reversing the order of digits of the mobile telephone number, introducing a period between each group of digits, and appending the carrier domain name at the end of the hostname (e.g., converting a phone number +011 (999) 555-1234 into a hostname of 4321.555.999.110.carrier.com). Because the hostname for a mobile station is obtained by converting the station's mobile telephone number, a mobile station wanting to send a message to a destination mobile station need only know the destination mobile station's telephone number in order to determine the destination mobile station's hostname, to obtain the destination mobile station's packet address from the network directory, and to send packet-based communications to the destination mobile station using the packet address.

To send the message, the first mobile station retrieves the mobile telephone number of the second mobile station, converts the mobile telephone number of the second mobile station into the hostname for the second mobile station, and queries the network directory to obtain the packet address associated with the hostname for the second mobile station. The first mobile station then formats the message for transmission through the packet network, and transmits the formatted message through the packet network to the obtained packet address of the second mobile station. If the second mobile station is not registered in the network directory, the first mobile station reverts to sending the message using a short, multimedia, or enhanced messaging service (SMS/MMS/EMS) to the mobile telephone number of the second mobile station.

Reference now is made in detail to the examples illustrated in the accompanying drawings and discussed below.

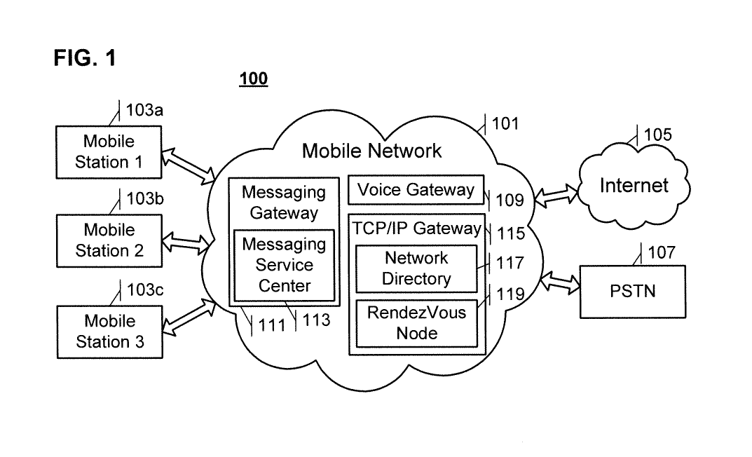

FIG. 1 is a simplified block diagram showing a system 100 for providing direct messaging between mobile stations using TCP/IP. Three mobile stations (MSs) 103a, 103b, 103c (referenced generally herein as MS 103) connect to mobile network 101 to obtain wireless communication services, such as voice, messaging, and/or packet-based communication services. To provide such services, the mobile network 101 may include various gateways such as a voice gateway 109, a messaging gateway 111, and a packet-based communication gateway such as a TCP/IP gateway 115. Each gateway may include one or more servers and communications links for enabling the MSs 103 to connect and communicate with corresponding entities. For example, the voice gateway 109 enables the MSs 103 to communicate with each other, with other MSs on the same or other mobile networks, and with a public switched telephone network (PSTN) 107, through the mobile network 101. The messaging gateway 111 enables the MSs 103 to exchange (i.e., send and receive) messages with each other and with other MSs on the same or other mobile networks. The TCP/IP gateway 115 enables the MSs 103 to access the Internet 105 and other packet-based communications services through the mobile network 101.

The messaging gateway 111 includes a mobile messaging service center 113, which may include a short message service center (SMSC) for receiving and sending short message service (SMS) messages, a multimedia message service center (MMSC) for receiving and sending multimedia message service (MMS) messages, and/or various other enhanced message service centers (EMSCs) for receiving and sending other types of enhanced message service (EMS) messages. When a mobile messaging service message is sent by a MS 103 or other device connected to the network 101, the messaging service message is routed by the mobile network 101 to the messaging service center 111. Upon receipt of the mobile messaging service message, the mobile messaging service center 111 transmits the received message to the appropriate entity (e.g., a destination MS, or other destination device).

As shown in FIG. 1, the packet-based communication TCP/IP gateway 115 can include a network directory 117 and a rendezvous node 119. When a MS 103 connects to the mobile network 101 and requests TCP/IP services, the MS 103 is assigned a packet address by the rendezvous node 119. The packet address generally is an IP address. In general, the rendezvous node 119 is configured to assign unique packet addresses to all MSs 103 connecting to the Internet 105 through the TCP/IP gateway 115 and rendezvous node 119. In some examples, the rendezvous node 119 may thus assign packet addresses to substantially all MSs 103 connecting to the Internet 105 through the mobile network 101 of a particular wireless service carrier. While the rendezvous node 119 is shown as forming part of the TCP/IP gateway 115 of mobile network 101 in FIG. 1, the rendezvous node 119 can instead, in some examples, be part of Internet 105. Additionally, while a single rendezvous node 119 is shown in FIG. 1, two or more rendezvous nodes 119 may more generally be included as part of the TCP/IP gateway 115 and/or the Internet 105.

In some examples, the rendezvous node 119 is a Dynamic Host Configuration Protocol (DHCP) server which assigns packet addresses to MSs 103. The rendezvous node 119 can assign packet addresses using dynamic allocation or static allocation. When using static allocation, a MS 103 is assigned the same packet address by the rendezvous node 119 each time the MS 103 requests TCP/IP services. When using dynamic allocation of packet addresses, the rendezvous node 119 assigns a packet address to a MS 103 for a limited time duration. The rendezvous node 119 generally keeps a record of the packet address assigned to each MS 103 and of the duration of time for which the packet address has been assigned. When a packet address is assigned, the rendezvous node 119 sends an acknowledgement message to the MS 103 including the assigned packet address and the duration of time for which the address has been assigned. In order for the MS 103 to retain the packet address for a period of time longer than the assigned time duration, the MS 103 renews the packet address with the rendezvous node 119 prior to the expiration of the time duration.

In some examples, the IP address assigned to a MS 103 by the rendezvous node 119 is a public packet address (e.g., a public IP address) that is unique to the MS 103 and uniquely identifies the MS 103 on the Internet 105. In general, however, the packet address assigned to a MS 103 by the rendezvous node 119 is a private packet address (e.g., a private IP address) that is unique to the MS 103 only within the private address space of the rendezvous node 119. In examples in which the packet address is a private packet address, the rendezvous node 119 performs network address translation (NAT) and/or port address translation (PAT) to IP packets transmitted between the MS 103 and the Internet 105 to ensure that the packets are correctly routed between the MS 103 and destination servers or URLs.

The network directory 117 includes a database or memory storage for associating packet addresses with hostnames. In some examples, the network directory 117 is a server, such as a domain name service (DNS) server or server system, which maintains information associated with each of a set of MSs or other devices that have registered with the network directory and that have assigned packet addresses. The network directory 117 may thus maintain information associating, for each registered packet address assigned to a MS 103 by the rendezvous node 119, a hostname associated with the packet address. In general, the hostname for a MS 103 is a domain name formed using the mobile number of the MS 103. The network directory 117 stores information for each MS 103 that has registered with the network directory 117. In some examples, the network directory 117 may store information for each MS that has been assigned a packet address by the rendezvous node 119.

While the network directory 117 is shown as forming part of the TCP/IP gateway 115 of mobile network 101 in FIG. 1, the network directory 117 can instead, in some examples, be part of Internet 105. Additionally, while a single network directory 117 is shown in FIG. 1, two or more network directories 117 forming a network directory system may more generally be included as part of the TCP/IP gateway 115 and/or the Internet 105. Multiple network directories 117 may be used, for example, to reduce the storage and processing loads sustained by each network directory individually.

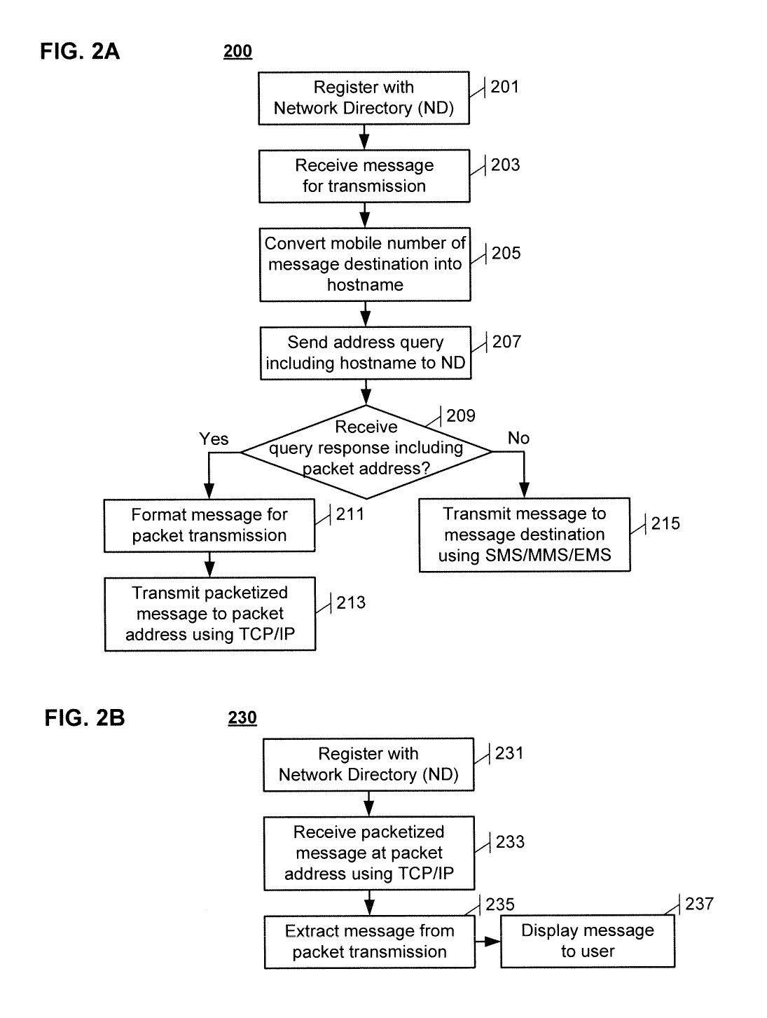

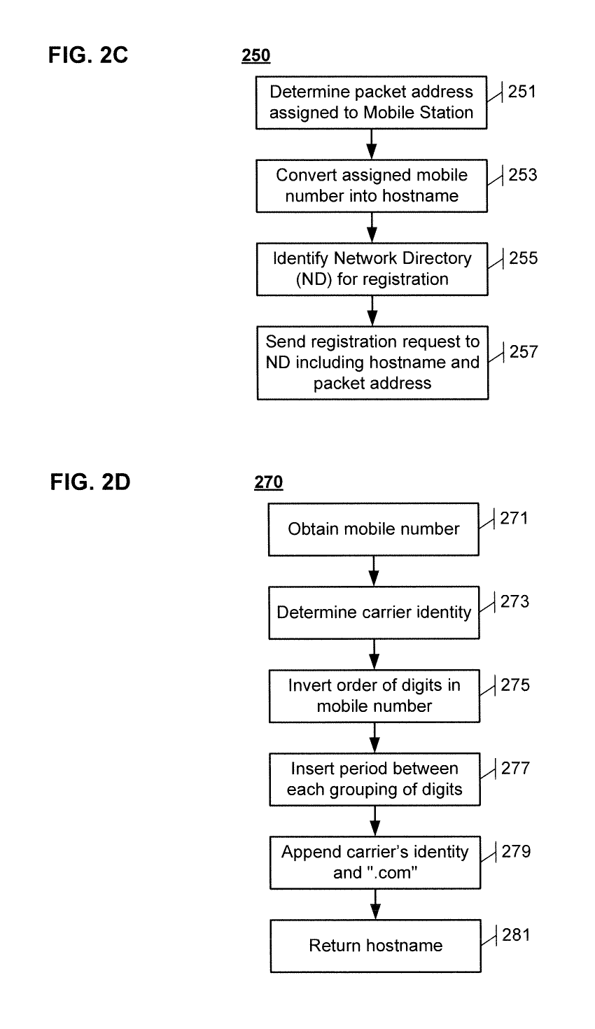

FIG. 2A is a flow diagram illustratively showing a method 200 in a MS 103 to provide direct messaging service from the MS to other MSs using packet-based (e.g., TCP/IP) communications.

The method 200 begins in operation 201 with the MS 103 registering with the network directory (ND) 117. In order to register with the ND 117, the MS 103 should have previously been assigned a packet address by the rendezvous node 119. The MS 103 prepares and sends a network directory registration request to the ND 117, the request including the packet address assigned to the MS by the rendezvous node and a hostname for uniquely identifying the MS in the ND 117. In examples in which the MS 103 is dynamically assigned a packet address, the request may include the packet address assigned to the MS along with the duration of time (or remaining duration of time) for which the packet address has been assigned to the MS 103 by the rendezvous node 119. The registration process is described in more detail in relation to FIG. 2C below. Once the MS 103 is registered with the ND 117, the method 200 proceeds to operation 203.

In operation 203, the MS 103 receives an instruction to initiate transmission of a message. The instruction may result from user input, from execution of a program (e.g., in the case of an automatic instruction), or from an externally received signal. In general, the message is a mobile messaging service message (e.g., SMS, MMS, EMS, or the like) that a user of the MS 103 has requested to be communicated from the MS 103, to another MS. However, the message may be any other type of message or communication that is requested to be transmitted from the MS 103. For example, the message may correspond to a request to transmit data, to begin a data stream, or to otherwise send information to a destination device. The message includes a destination identifier or address, which generally takes the form of a destination mobile number identifying another MS 103 to which the message should be transmitted. In response to receiving the message for transmission from the MS 103, the method 200 proceeds to operation 205.

The MS 103 retrieves the destination mobile number from the message in operation 205, and converts the destination mobile number into a hostname for identifying the destination. The destination hostname is a hostname uniquely identifying the other MS 103 to which the message should be transmitted, and is generally obtained from the destination mobile number. The conversion process for obtaining the hostname is described in more detail in relation to FIG. 2D below.

Once the MS 103 obtains the destination hostname, the MS 103 generates and sends an address query message to the ND 117 in operation 207. The address query message includes the destination hostname, and requests the ND 117 to identify a packet address corresponding to the destination hostname. The address query message generally also includes the packet address of the MS 103 sending the query, such that the ND 117 can send the query response back to the packet address of the MS 103 having sent the query. In some examples, the address query can take the form of a domain name service (DNS) query.

In response to receiving the address query message, the ND 117 determines whether it stores any packet address associated with the received destination hostname. If an associated packet address is found, the ND 117 retrieves the packet address and transmits an address query response message (e.g., a DNS response) including the retrieved packet address to the MS 103. If no associated packet address is found, the ND 117 generally either does nothing, or the ND 117 sends an address query response message indicating that no packet address associated with the received hostname could be located. Alternatively, if no associated packet address is found, the ND 117 can send an address query response including a packet address assigned to a rendezvous node 119 associated with the carrier domain of the received destination hostname.

In some examples, the ND 117 may not send an address query response message even though the ND 117 determines that it stores a packet address associated with the received destination hostname. For example, the ND 117 may not send an address query response message if the ND 117 determines that a current IP network load exceeds a threshold (e.g., so as to reduce the IP network load by causing messages to be sent by SMS/MMS/EMS in operation 215 rather than over the IP network in operation 213); if the ND 117 determines that a message is a high priority message which should be sent by SMS/MMS/EMS in operation 215; or if the ND 117 determines that the sending MS and/or the destination MS are subject to data communication restrictions (e.g., as a result of a previous data communication misuse by the MS, a current or previous data plan overage by the MS, or the like).

In operation 209, the MS 103 determines whether an address query response message including a destination packet address has been received. If a response including a packet address corresponding to the destination hostname and corresponding destination MS is received, the method 200 proceeds to operation 211. However, if a response is received that does not include a packet address corresponding to the destination hostname, or if no response is received within a predetermined time period following the sending of the address query, the method proceeds to operation 215.

If a response is received including a packet address, in operation 211, the MS 103 formats the message received in operation 203 for packet transmission. For example, the MS 103 may format the message into one or more IP packets having the received destination packet address as a destination address. Each IP packet includes a header which can include the destination packet address as the IP destination address of the packet, and the packet address of the sending MS as the IP source address of the packet. The header may also include the mobile numbers of the sending and/or destination mobile stations, as well as other control information for the IP packet including error detection codes (e.g., checksum bit(s)).

In operation 213, the MS 103 transmits the formatted/packetized message to the destination packet address using TCP/IP. If the query response received in operation 209 included a packet address for a carrier domain (rather than a packet address for the destination mobile station), the MS 103 may include in the formatted/packetized message an identifier for the destination mobile station (e.g., the destination mobile number and/or destination hostname), and transmit the formatted/packetized message to the packet address for the carrier domain. Upon receipt of the message by the server assigned the packet address for the carrier domain, the server may in turn transmit the formatted/packetized message to the destination mobile station if the destination mobile station is in the server's local address space.

If a response is received that does not include a packet address, or if no response to the address query is received within a predetermined amount of time set in the MS 103, the MS 103 determines in operation 215 that the message cannot be transmitted directly to the destination MS using packet-based communications. As a result, the MS 103 transmits the message to the destination MS using other messaging means, such as SMS, MMS, EMS, or the like. In some embodiments, the MS 103 may retry (or repeat) operations 207 and 209 one or more times when a response does not include a packet address and/or when no response is received, and may proceed to operation 215 only after the one or more retries have failed.

In examples in which the message received for transmission in operation 203 is a mobile messaging service message, the method 200 may send the message using packet-based communications without users' knowledge. In particular, a user of the sending MS 103 may have composed the message and requested transmission of the message using a standard mobile messaging service application or interface. The user may thus assume that the message is being sent as a mobile messaging service message, and the MS 103 may perform method 200 so as to send the message using packet-based communications instead of using a mobile messaging service.

In some examples, the packet address of the destination MS is a private packet address that is unique to the destination MS within the private address space of the rendezvous node 119. In such examples, the sending MS of method 200 may generally also be located within the local address space of the same rendezvous node 119, such that the sending MS transmits the packetized message within the private address space of the rendezvous node 119.

More generally, however, if the sending and destination MSs are not located within the same address space, the sending and destination MSs may nonetheless exchange packetized messages if a suitable communication connection exists between the sending MS's address space and the destination MS's address space. For example, the sending and destination MSs may exchange packetized messages if rendezvous nodes 119 associated with each of the MSs are connected to each other through one or more routers, gateways, or other communication links, and if the rendezvous nodes 119 can perform address translation between the address spaces. In one example, in response to the address query sent in operation 207, a sending MS attempting to send a message to a destination MS in a different address space may receive a query response in operation 209 including a packet address assigned to the rendezvous node 119 of the destination MS's carrier domain. In operation 213, the sending MS may transmit the packetized message to the packet address assigned to the rendezvous node 119 of the destination MS's carrier domain. Upon receipt of the packetized message, the rendezvous node 119 may retrieve an identifier for the destination MS from the message, query the ND 117 of the destination address space to obtain a packet address for the destination MS, and forward the packetized message to the obtained packet address associated with the destination MS.

In other examples, the packet address of the destination MS is a public packet address that uniquely identifies the destination MS on the Internet 105. In such examples, the sending MS of method 200 may generally be located anywhere on the Internet 105, and the sending MS may transmit the packetized message to the public packet address from anywhere on the Internet 105.

FIG. 2B is a flow diagram illustratively showing operations of a method 230 in a MS 103 to provide direct messaging service to the MS from other MSs using packet-based communications (e.g., TCP/IP). The MS 103 performing method 230 may, for example, correspond to the destination MS to which a packetized message is transmitted in operation 213 of method 200.

In order to receive packetized messages using TCP/IP, the MS 103 registers with the ND 117. The method 230 thus begins at operation 231 with the MS 103 registering with the ND 117. The registration process may be substantially similar to the registration process described in relation to operation 201 of FIG. 2A, and described in more detail in relation to FIG. 2C below. Once the MS 103 is registered with the ND 117, the method 230 proceeds to operation 233.

The MS 103 is ready to receive packetized messages over TCP/IP. In operation 233, the MS 103 may receive such a packetized message transmitted to the packet address assigned to the MS 103 by the rendezvous node 119. The received message may be a packetized message transmitted from another MS 103 performing operation 213 of method 200, for example.

In response to receiving the packetized message, the MS 103 extracts the message from the packet transmission in operation 235, for example by converting the received packetized message into a messaging service message or other message format for use on the MS 103. When the message is extracted, the MS 103 may display the message to a user of the MS 103 in operation 237. Alternatively or additionally, the MS 103 can perform other operations with the extracted message, including operations commonly performed upon receipt of a messaging service message on the MS 103, such as causing a ringtone or other auditory, visual, or tactile/vibrating alert to be issued by the MS 103.

FIG. 2C is a flow diagram illustratively showing operations of a method 250 in a MS 103 for registering the MS with a network directory (ND) 117. The method 250 may be performed, for example, as part of operation 201 of method 200 and operation 231 of method 230.

The method 250 begins at operation 251 with the MS 103 determining a packet address assigned to the MS 103 by the rendezvous node 119. When the MS 103 connects to the mobile network 101 and requests TCP/IP services, the MS 103 is assigned a packet address by the rendezvous node 119. Upon being assigned a packet address by the rendezvous node 119, the MS 103 may receive from the rendezvous node 119 a message indicating the packet address assigned to it.

In operation 253, the MS 103 retrieves a mobile number assigned to the MS 103, such as a mobile directory number (MDN) or a mobile telephone number (MTN). The MS 103 then converts the assigned mobile number, which uniquely identifies the MS on a telephony network, into a hostname that uniquely identifies the MS in a packet-based IP network. The conversion process for obtaining the hostname is described in more detail in relation to FIG. 2D below.

The MS 103 proceeds to search for and identify a ND 117 with which to register in operation 255. In examples in which only a single ND 117 is provided, the MS 103 identifies the single ND 117 for registration. However, in examples in which multiple NDs 117 are provided, the MS 103 searches for the ND 117 that is a closest match to the MS's hostname. In some examples, the MS 103 may identify the ND 117 using the Access Point Name (APN) assigned to the MS 103 for access to the Internet, for example by searching for a network directory 117 associated with the MS's APN. In general, each ND 117 has a directory hostname. The hostnames of both MSs and NDs are composed of a parent domain name (e.g., ‘carrier.com’, or other parent domain name of a mobile station's APN) which is optionally preceded by one or more local domain names (e.g., ‘110’ in ‘110.carrier.com’). The closeness of a match between a MS hostname and a ND directory hostname may be evaluated based on both hostnames having the same parent domain name, and the hostnames having as many matching local domain names when read in order from right to left. For example, among the ND directory hostnames ‘110. carrier.com’, ‘999.110.carrier.com’, and ‘555.999.ABC.carrier.com’, the closest match to the MS hostname ‘4321.555.999.110.carrier.com’ is the ND directory hostname ‘999.110.carrier.com’.

In order to search for a ND 117 with which to register, a MS 103 may retrieve its own hostname (e.g., ‘4321.555.999.110.carrier.com’), remove the left-most local domain name from the hostname (e.g., to obtain a directory hostname ‘555.999.110.carrier.com’), and search for a ND 117 having the obtained directory hostname. If a matching ND 117 is found, then the matching ND 117 is the closest match to the MS's hostname (e.g., in this case, a ND 117 having the hostname ‘555.999.110. carrier.com’ would be the closest match). If no match is found, however, the MS 103 may proceed to remove the next left-most local domain name from the hostname (e.g., to obtain a directory hostname ‘999.110.carrier.com’), and to search for a ND 117 having the obtained directory hostname. The process can be repeated until a matching ND 117 is found. If no ND 117 matching the parent domain name is found (e.g., no ND 117 matching ‘carrier.com’), the search fails and no ND 117 is returned.

When a ND 117 is identified for registration, the MS 103 proceeds to generate and send a network directory registration request to the identified ND 117 in operation 257. The network directory registration request generally includes the packet address assigned to the MS 103 by the rendezvous node 119, and the hostname uniquely identifying the MS 103. Upon receiving the network directory registration request, the ND 117 stores information associating the received packet address assigned to the MS 103 with the hostname associated with the MS 103. If the registration in the ND 117 is successful, the ND 117 can optionally transmit a network directory registration confirmation message to the MS 103 indicating that the registration was completed successfully.

In examples in which the MS 103 is dynamically assigned a packet address, the network directory registration request may additionally include the duration of time (or remaining duration of time) for which the packet address has been assigned to the MS by the rendezvous node 119. In such examples, the ND 117 may additionally store the duration of time (or remaining duration of time) in association with the received packet address and hostname. If the ND 117 does not receive a renewal request from the MS 103 before the expiration of the duration of time, the ND 117 may determine that the packet address is no longer associated with the MS 103 and the ND 117 may remove the information associating the received packet address and hostname for the MS 103 from its database or memory. However, if the ND 117 receives a renewal request from the MS 103 before the expiration of the duration of time, the ND 117 may update the direction of time (or remaining duration of time) with a new time duration value included in the renewal request.

The operation of identifying a ND 117 described in relation to operation 255 may additionally be performed at other times. For example, when a sending MS sends an address query including a destination hostname to a ND in operation 207 of method 200, the sending MS may firstly identify a ND that is the closest match to the destination hostname. The sending MS may then send the address query to the identified ND corresponding to the closest match.

FIG. 2D is a flow diagram illustratively showing operations of a method 270 in a MS 103 for converting a mobile number into a hostname. The method 270 may be performed, for example, in operation 205 of method 200 and operation 253 of method 250.

The method 270 begins at operation 271 with the MS 103 obtaining the mobile number to be converted into a hostname. The mobile number may be the MS's own mobile number (e.g., as in operation 253 of method 250), or the mobile number of another MS such as a destination MS (e.g., as in operation 205 of method 200). The method 270 will be described using an exemplary mobile number ‘+011 (999) 555-1234’ including a country code (i.e., ‘+011’), an area code (e.g., ‘(999)’), and a local number (i.e., ‘555-1234’).

In operation 273, the MS 103 determines the identity of a wireless carrier associated with the mobile number. The MS may store the identity of the wireless carrier associated with the mobile number (e.g., if the mobile number is the MS's own mobile number), the MS may set the identity of the wireless carrier to a default identity (e.g., the default identity may be the identify of the MS's own carrier), or the MS may communicate with a carrier identity server and request the server to identify a wireless carrier associated with the mobile number. In the example, the MS 103 may determine the carrier identity corresponding to the mobile number ‘+011 (999) 555-1234’ to be ‘carrier’, and may identify a domain name associated with the carrier identity as ‘carrier.com’

In operations 275-279, the MS 103 assembles the hostname for the mobile number based on the mobile number and the carrier identity. First, the MS removes punctuation from the mobile number, and inverts or reverses the order of digits in the mobile number. In the example, the mobile number ‘+011 (999) 555-1234’ thus becomes ‘4321 555 999 110’. Next, the MS inserts a period separator between each grouping of digits. Digit groupings can, for example, correspond to the country code, area code, and prefix. In the example, the inverted number ‘4321 555 999 110’ thus becomes ‘4321.555.999.110’. Finally, the carrier's identity and a ‘com’ suffix, or a domain name associated with the carrier, is appended to the end of the modified number. As such, the number ‘4321.555.999.110’ becomes ‘4321.555.999.110.carrier.com’. The process of operations 275-279 thus provides a hostname, such as ‘4321.555.999.110.carrier.com’, that uniquely identifies the MS having a mobile number (e.g., ‘+011 (999) 555-1234’) and has a format corresponding to an Internet hostname. The reversal of digits in the mobile number can be used to form a hostname amenable to hierarchical searches by placing the reversed country code as the top-most local domain, the reversed area code as the second local domain, and the reversed prefix as the third local domain. The hostname is returned in operation 281.

The conversion of a mobile number into a hostname described in relation to method 270 is fully reversible. In particular, from a particular hostname, the original mobile number can be retrieved by performing an inverse process to that described in method 270. In particular, from the hostname ‘4321.555.999.110.carrier.com’, the carrier and ‘.com’ suffix are removed to obtain ‘4321.555.999.110’. The order of digits is reversed to obtain ‘011.999.555.1234’. Finally, the period separators are removed, and the number put into standard mobile number format to obtain the mobile number ‘+011 (999) 555-1234’. A hostname can thus be used to retrieve a mobile number associated with a MS.

The methods 200, 230, 250, and 270 described in relation to FIGS. 2A-2D can be used to transmit a message from a first mobile station to a second mobile station as one or more IP packets including, as their destination address, the packet address of the second mobile station. The methods thus enable direct point-to-point messaging between the first and second mobile stations, and do not require that the message or IP packets be routed through any server. As such, the methods require minimal infrastructure for operation, and in particular do not require message service centers (MSCs) or other specialized servers for operation (except as a back-up system, used for example in operation 215 when the packet-based communication fails).

While described in relation to messaging applications, the methods 200, 230, 250, and 270 can be used in various other contexts. For example, the methods may be used to enable other types of communications between two MSs, including any type of communication over an IP network. For example, the methods described herein may be used to transmit or stream audio, video, or various other types of data over TCP/IP from a first mobile station to a second mobile station at the destination packet address. The methods may further be used, in conjunction with encryption methods, to enable secure, encrypted communication over TCP/IP between first and second mobile stations.

In addition, while the method 200 refers to a sending mobile station, a sending station may more generally be any device configured to perform operations 203-213 of method 200. For example, the sending station may more generally be a computer that is in communication with the ND 117, and that can send an address query to the ND including a hostname corresponding to a destination station, receive a query response from the ND, and transmit a packetized message to the packet address included in the query response. Similarly, while the method 200 refers to a destination mobile station, a destination station may more generally be any device configured to perform operations 231-237 of method 230. For example, the destination station may more generally be a computer that is in communication with the ND 117, and that can register with the ND using the computer's packet address and a hostname corresponding to a destination mobile number, receive a packetized message transmitted to the computer's packet address, and extract the message from the received packetized message.

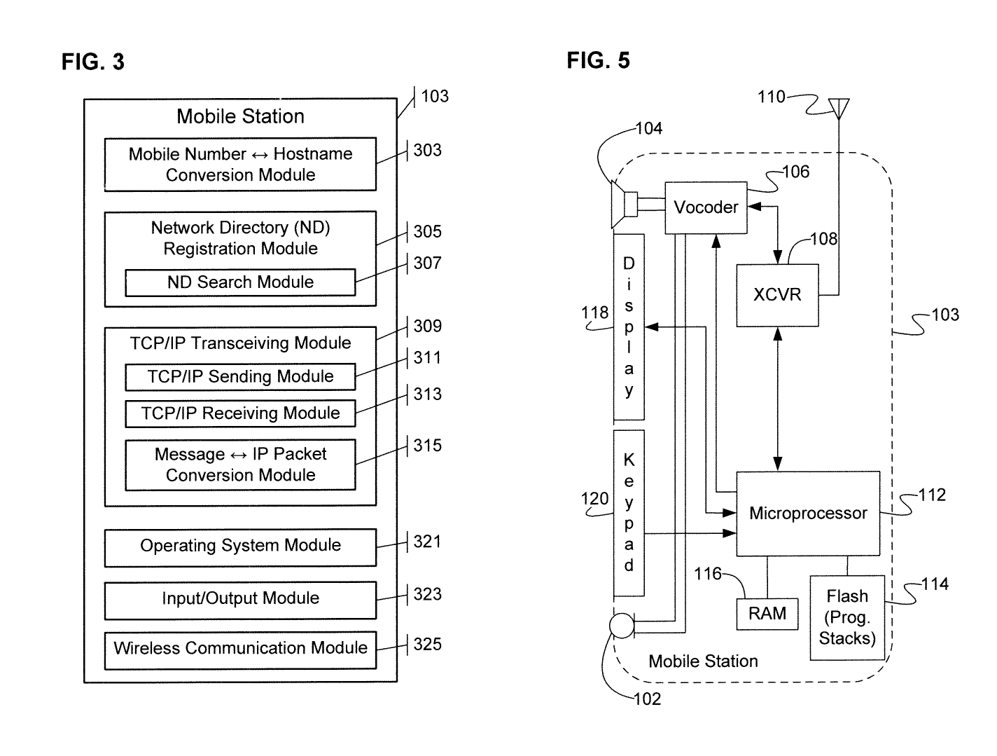

Direct messaging between MSs using packet-based communications may be implemented on MSs configured for packet-based TCP/IP communications. FIG. 3 is a simplified block diagram showing elements of a MS 103 used to implement the methods described herein.

The MS 103 of FIG. 3 includes an operating system module 321, an input/output module 323, and a wireless communication module 325. The modules 321-325 may be substantially similar to the operating system, input/output, and communication modules may be used to provide established mobile station functionalities, including phone communications and user applications found on many mobile stations.

In addition, the MS 103 of FIG. 3 includes a conversion module 303 for performing conversions between mobile numbers and hostnames; a registration module 305 for registering the MS 103 with a network directory 117; and a packet-based TCP/IP transceiving module 309 for enabling the packet-based communication of messages. The conversion module 303 may perform functions such as those described in relation to method 270 and FIG. 2D above, so as to perform conversions between mobile numbers and hostnames. The registration module 305 may perform functions such as those described in relation to method 250 and FIG. 2C above, so as to register the MS 103 with a network directory 117. The registration module 305 may additionally include a search module 307 for identifying a network directory 117 that is the closest match to a hostname. The search module 307 may perform functions such as those described in relation to operation 255 of method 250, for example. The packet-based TCP/IP transceiving module 309 can include a TCP/IP sending module 311 and a TCP/IP receiving module 313, used for sending and receiving packet-based communications in the MS 103. The packet-based TCP/IP transceiving module 309 can additionally include a conversion module 315 used to convert messages into a format for packet transmission and/or to convert packet transmissions back into messages. The conversion module 315 may perform functions such as those described in relation to operation 211 of method 200 and operation 235 of method 230.

The modules 303-325 described herein may be implemented as software, for example in the form of machine readable instructions embodied in non-transitory machine readable media for execution in a processor of a mobile station 103. The modules may alternatively be implemented in a combination of hardware and software in a mobile station 103.

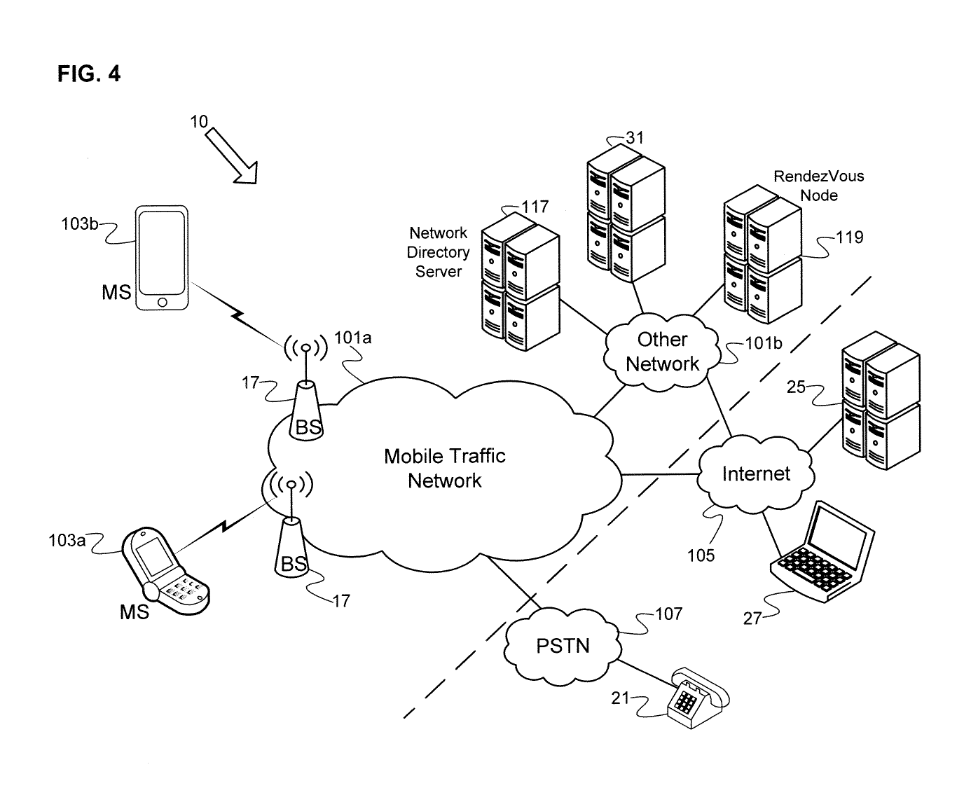

FIG. 4 illustrates a system 10 offering a variety of mobile communication services, including direct messaging between users' mobile stations using packet-based communications. The example shows simply two mobile stations (MSs) 103a and 103b as well as a mobile communication network 101 including a mobile traffic network 101a and another network 101b. The stations 103a and 103b (referenced generally as 103) are examples of mobile stations that may be used for direct messaging using packet-based communications. However, the network will provide similar communications for many other similar users as well as for mobile devices/users that do not participate in the direct messaging service using packet-based communications. The network 101 provides mobile wireless communications services to those stations as well as to other mobile stations (not shown), for example, via a number of base stations (BSs) 17. The present techniques may be implemented in any of a variety of available mobile networks 101 and/or on any type of mobile station compatible with such a network 101, and the drawing shows only a very simplified example of a few relevant elements of the network 101 for purposes of discussion here.

The wireless mobile communication network 101 might be implemented as a network conforming to the code division multiple access (CDMA) IS-95 standard, the 3rd Generation Partnership Project 2 (3GPP2) wireless IP network standard or the Evolution Data Optimized (EVDO) standard, the Global System for Mobile (GSM) communication standard, a time division multiple access (TDMA) standard or other standards used for public mobile wireless communications. The mobile stations 103 are capable of voice telephone communications through the network 101, and for the direct messaging services using packet-based communications, the exemplary devices 103a and 103b are capable of data communications through the particular type of network 101 (and the users thereof typically will have subscribed to data service through the network).

The network 101 allows users of the mobile stations such as 103a and 103b (and other mobile stations, not shown) to initiate and receive telephone calls to each other as well as through the public switched telephone network or “PSTN” 107 and telephone stations 21 connected to the PSTN. The network 101 typically offers a variety of data services via the Internet 105, such as downloads, web browsing, email, etc. By way of example, the drawing shows a laptop PC type user terminal 27 as well as a server 25 connected to the Internet 105; and the data services for the mobile stations 103 via the Internet 105 may be with devices like those shown at 25 and 27 as well as with a variety of other types of devices or systems capable of data communications through various interconnected networks. The mobile stations 103 of users of the direct messaging service using packet communications also can receive and execute applications written in various programming languages, as discussed more later.

Mobile stations 103 can take the form of portable handsets, smart-phones or personal digital assistants, although they may be implemented in other form factors. Program applications, including an application to assist in the direct messaging service using packet communications can be configured to execute on many different types of mobile stations 103. For example, a mobile station application can be written to execute on a binary runtime environment for mobile (BREW-based) mobile station, a Windows Mobile based mobile station, Android, I-Phone, Java Mobile, or RIM based mobile station such as a BlackBerry or the like. Some of these types of devices can employ a multi-tasking operating system.

The mobile communication system 10 can be implemented by a number of interconnected networks. Hence, the overall system 10 may include a number of radio access networks (RANs), as well as regional ground networks interconnecting a number of RANs and a wide area network (WAN) interconnecting the regional ground networks to core network elements. A regional portion of the system 10, such as that serving mobile stations 103, can include one or more RANs and a regional circuit and/or packet switched network and associated signaling network facilities.

Physical elements of a RAN, operated by one of the mobile service providers or carriers, include a number of base stations represented in the example by the base stations (BSs) 17. Although not separately shown, such a base station 17 can include a base transceiver system (BTS), which can communicate via an antennae system at the site of the base station and over the airlink with one or more of the mobile stations 103, when the mobile stations are within range. Each base station can include a BTS coupled to several antennae mounted on a radio tower within a coverage area often referred to as a “cell.” The BTS is the part of the radio network that sends and receives RF signals to/from the mobile stations 103 that are served by the base station 17.

The radio access networks can also include a traffic network represented generally by the cloud at 101a, which carries the user communications and data for the mobile stations 103 between the base stations 17 and other elements with or through which the mobile stations communicate. The network can also include other elements that support functionality other than device-to-device media transfer services such as messaging service messages and voice communications. Specific elements of the network 101a for carrying the voice and data traffic and for controlling various aspects of the calls or sessions through the network 101a are omitted here for simplicity. It will be understood that the various network elements can communicate with each other and other aspects of the mobile communications system 10 and other networks (e.g., the public switched telephone network (PSTN) and the Internet) either directly or indirectly.

The carrier will also operate a number of systems that provide ancillary functions in support of the communications services and/or application services provided through the network 101a, and those elements communicate with other nodes or elements of the network 101a via one or more private IP type packet data networks 101b (sometimes referred to as an Intranet), i.e., a private networks. Generally, such systems are part of or connected for communication via the private network 101b. However, the systems outside of the private network could serve the same functions as well. Examples of such systems, in this case operated by the network service provider as part of the overall network 101, which communicate through the intranet type network 101b, include one or more application servers 31 and related authentication servers, as well as one or more network directory servers 117 and rendezvous nodes 119.

A mobile station 103 communicates over the air with a base station 17 and through the traffic network 101a for various voice and data communications, e.g. through the Internet 105 with a server 25 and/or application servers 31. If the mobile service carrier offers the direct messaging service using packet communications, the service may rely on a network directory and/or rendezvous node hosted on a carrier operated server 117/119, for communication via the networks 101a and 101b. Alternatively, the direct messaging service may be provided by a separate entity (alone or through agreements with the carrier), in which case, the service may be hosted on servers such as server 25 connected for communication via the networks 101a and 105. Servers such as 25 and 31 may provide any of a variety of common application or service functions in support of or in addition to application programs running on the mobile station 103. However, for purposes of further discussion, we will focus on functions thereof in support of the mobile direct messaging service using packet communications. For a given service, including the direct messaging service, application programs within the mobile stations 103 may be considered as peers providing direct peer-to-peer messaging between the stations.

The direct messaging service using packet communication under consideration here may be delivered to touch screen type mobile stations as well as to non-touch type mobile stations. Hence, our simple example shows the mobile station 103a as a non-touch type mobile station and shows the mobile station 103b as a touch screen type mobile station. Implementation of the direct messaging service will involve at least some execution of programming in the mobile stations as well as data communications through the network 101, to/from the mobile stations.

For purposes of such a discussion, FIG. 5 provides a block diagram illustration of an exemplary mobile station 103. The mobile station 103 includes a microphone 102, speaker 104 and vocoder 106, for audio input and output functions, much like in the earlier example. The mobile station 103 also includes at least one digital transceiver (XCVR) 108, for digital wireless communications, although the handset 103 may include an additional digital or analog transceiver. The concepts discussed here encompass embodiments of the mobile station 103 utilizing any digital transceivers that conform to current or future developed digital wireless communication standards. The transceiver 108 provides two-way wireless communication of information, such as vocoded speech samples and/or digital and packet data information, in accordance with the technology of the network 101. The transceiver 108 also sends and receives a variety of signaling messages in support of the various voice and data services provided via the mobile station 103 and the communication network. Each transceiver 108 connects through RF send and receive amplifiers (not separately shown) to an antenna 110. The transceiver may also support various types of mobile messaging services, such as short message service (SMS), enhanced messaging service (EMS) and/or multimedia messaging service (MMS).

A microprocessor 112 serves as a programmable controller for the mobile station 103, in that it controls all operations of the mobile station 103 in accord with programming that it executes, for all normal operations, and for operations involved in the direct messaging service using packet communication under consideration here. In the example, the mobile station 103 includes flash type program memory 114, for storage of various program routines and mobile configuration settings. The mobile station 103 may also include a non-volatile random access memory (RAM) 116 for a working data processing memory. Of course, other storage devices or configurations may be added to or substituted for those in the example. Hence, outlined above, the mobile station 103 includes a processor, and programming stored in the flash memory 114 configures the processor so that the mobile station is capable of performing various desired functions, including in this case the functions involved in the technique for providing direct messaging between mobile stations.

The mobile station 103 may have user interface elements including a display 118 and keypad 120, or a touch screen display arrangement.

As shown by the above discussion, at least some of the functions supporting the direct messaging service between mobile stations using packet-based communications may be implemented on computers connected for data communication via the components of a packet data network, operating as a network directory 117 and/or as a rendezvous node 119 as shown in FIGS. 1 and 4. Although special purpose devices may be used, such devices also may be implemented using one or more hardware platforms intended to represent a general class of data processing device commonly used to run “server” programming so as to implement the network directory and packet address assignment functions discussed above, albeit with an appropriate network connection for data communication.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. instructions for implementing direct messaging to/from a mobile station, or files used for maintaining the network directory database. The software code is executable by the general-purpose computer that functions as a mobile station, as a network directory server, and/or as a rendezvous node device. In operation, the code is stored within the mobile station or general-purpose computer platform. At other times, however, the software may be stored at other locations and/or transported for loading into the appropriate mobile station or general-purpose computer system, such as the computer system of a network directory server or a rendezvous node. Execution of such code by a processor of the mobile station or the computer platform enables the station or platform to implement the methodology for providing or supporting direct messaging between mobile stations using packet communications, in essentially the manner performed in the implementations discussed and illustrated herein.

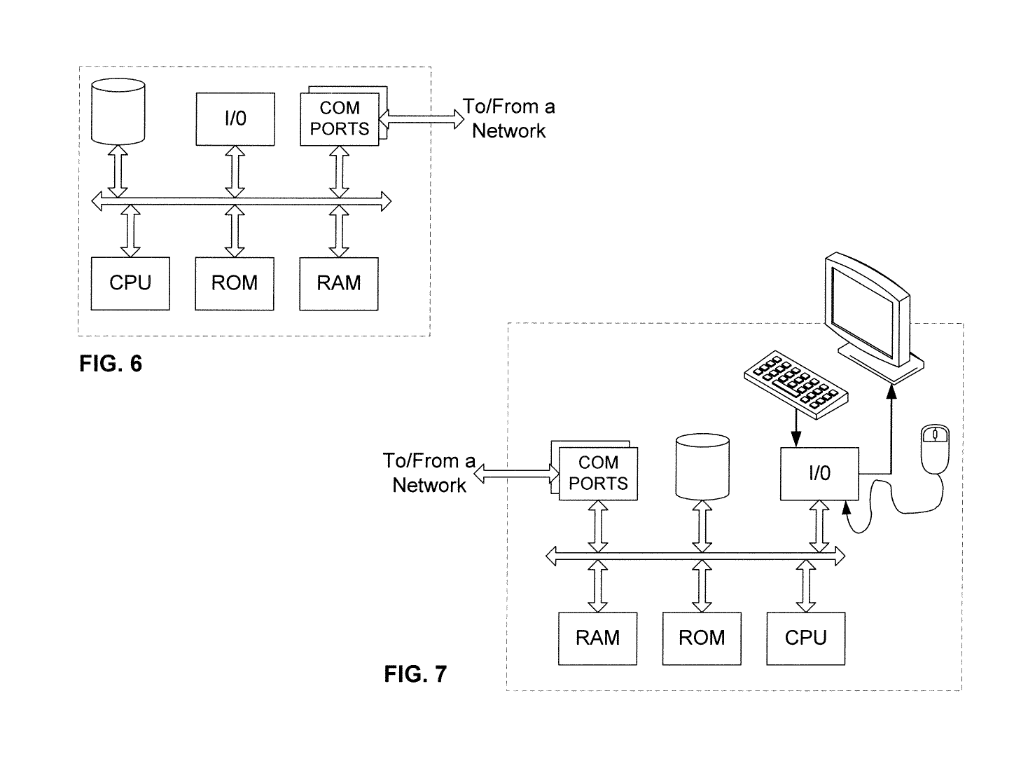

FIGS. 6 and 7 provide functional block diagram illustrations of general purpose computer hardware platforms. FIG. 6 illustrates a network or host computer platform, as may typically be used to implement a server. FIG. 7 depicts a computer with user interface elements, as may be used to implement a personal computer or other type of work station or terminal device, although the computer of FIG. 7 may also act as a server if appropriately programmed.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature. Of course, the server functions may be implemented in a distributed fashion on a number of similar platforms, to distribute the processing load.

Hence, aspects of the methods of direct messaging between mobile stations using packet-based communications outlined above may be embodied in programming, e.g. for a mobile station and/or for an appropriate server computer. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the carrier into the mobile station, or into the computer platform that will be the network directory server 117. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s), mobile stations, or the like, such as may be used to implement the various devices shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method, comprising steps of:
responsive to an instruction to initiate communication of a messaging service message from a first mobile station to a second mobile station, sending an address query from the first mobile station containing a destination hostname corresponding to a mobile number assigned to the second mobile station through a mobile network;
receiving, via the mobile network, a response to the address query containing a packet address assigned to the second mobile station;
in response to receiving the packet address assigned to the second mobile station, formatting the messaging service message into one or more packets containing the messaging service message and having the packet address assigned to the second mobile station as a destination address; and
sending the one or more packets containing the messaging service message and having the packet address assigned to the second mobile station as the destination address, from the first mobile station through a packet communication service of the mobile network.

2. The method of claim 1, further comprising:
receiving a further instruction to initiate communication of another messaging service message from the first mobile station to a third mobile station;
responsive to the further input, sending an address query from the first mobile station containing a destination hostname corresponding to a mobile number assigned to the third mobile station; and
upon failure to receive a response with a packet address assigned to the third mobile station, sending the other messaging service message as a mobile messaging service message through the mobile network.

3. The method of claim 2, wherein upon the other messaging service message being a text message, the sending of the other messaging service message uses a short messaging service (SMS) of the mobile network.

4. The method of claim 2, wherein upon the other messaging service message being a multimedia messaging service message, the sending of the other messaging service message uses a multimedia messaging service (MMS) of the mobile network.

5. The method of claim 1, wherein:
the address query is a domain name service (DNS) query and is sent through the mobile network to a DNS server system; and
the response is a DNS response received through the mobile network from the DNS server system.

6. The method of claim 5, further comprising:
prior to the sending the address query, identifying a DNS server of the DNS server system having a directory hostname that is a closest match to the destination hostname,
wherein the address query is sent through the mobile network to the DNS server identified as the closest match.

7. The method of claim 5, further comprising:
generating and transmitting a registration request message from the first mobile station to the DNS server system,
wherein the registration request message includes a packet address assigned to the first mobile station and a hostname corresponding to a mobile number assigned to the first mobile station.

8. The method of claim 1, further comprising:
converting, in the first mobile station, the mobile number assigned to the second mobile station into a hostname for uniquely identifying the second mobile station.

9. The method of claim 8, wherein the converting the mobile number assigned to the second mobile station into a hostname comprises:
removing punctuation from the mobile number assigned to the second mobile station;
reversing the order of digits in the mobile number having the punctuation removed;
inserting one or more period separators between each grouping of digits in the mobile number having the order of digits reversed; and
appending to the end of the mobile number having one or more period separators a domain name of a carrier associated with the second mobile station, to obtain the hostname for uniquely identifying the second mobile station.

10. The method of claim 1, wherein:
the first mobile station has a packet address assigned thereto that is a private packet address that is unique to the first mobile station within a private address space; and
the packet address assigned to the second mobile station is a private packet address that is unique to the second mobile station within the private address space.

11. The method of claim 1, wherein:
the packet address assigned to the second mobile station is a public packet address that uniquely identifies the second mobile station on the Internet.

12. An article of manufacture comprising:
programming to configure the first mobile station to implement the method of claim 1; and
a non-transitory machine readable medium embodying the programming.

13. A mobile station, comprising:
a wireless transceiver configured to provide wireless communication via a mobile network;
at least one user interface element configured for message input or output;
a processor coupled to the wireless transceiver and the at least one user interface element;
a storage device accessible to the processor; and
programming in the storage device, wherein execution of the programming by the processor configures the mobile station to perform functions including functions to:
responsive to an instruction to initiate communication of a messaging service message from the mobile station to a second mobile station, send an address query from the mobile station containing a hostname corresponding to a mobile number assigned to the second mobile station through the mobile network;
receive, via the mobile network, a response to the address query containing a packet address assigned to the second mobile station;
in response to receiving the packet address assigned to the second mobile station, format the messaging service message into one or more packets containing the messaging service message and having the packet address assigned to the second mobile station as a destination address; and
send the one or more packets containing the messaging service message and having the packet address assigned to the second mobile station as the destination address, from the mobile station through a packet communication service of the mobile network.

14. The mobile station of claim 13, wherein execution of the programming by the processor further configures the mobile station to perform functions including functions to:
receive a further instruction to initiate communication of another messaging service message from the mobile station to a third mobile station;
responsive to the further input, send an address query from the mobile station containing a destination hostname corresponding to a mobile number assigned to the third mobile station; and
upon failure to receive a response with a packet address assigned to the third mobile station, send the other messaging service message as a mobile messaging service message through the mobile network.

15. The mobile station of claim 14, wherein upon the other messaging service message being a text message, the sending of the other messaging service message uses a short messaging service (SMS) of the mobile network.

16. The mobile station of claim 14, wherein upon the other messaging service message being a multimedia messaging service message, the sending of the other messaging service message uses a multimedia messaging service (MMS) of the mobile network.

17. The mobile station of claim 13, wherein:
the address query is a domain name service (DNS) query and is sent through the mobile network to a DNS server system; and
the response is a DNS response received through the mobile network from the DNS server system.

18. The mobile station of claim 17, wherein execution of the programming by the processor further configures the mobile station to perform functions including functions to:
prior to sending the address query, identify a DNS server of the DNS server system having a directory hostname that is a closest match to the destination hostname,
wherein the address query is sent through the mobile network to the DNS server identified as the closest match.

19. The mobile station of claim 17, wherein execution of the programming by the processor further configures the mobile station to perform functions including functions to:
generate and transmit a registration request message from the mobile station to the DNS server system,
wherein the registration request message includes a packet address assigned to the mobile station and a hostname corresponding to a mobile number assigned to the mobile station.

20. The mobile station of claim 13, wherein execution of the programming by the processor further configures the mobile station to perform functions including functions to:
convert, in the mobile station, the mobile number assigned to the second mobile station into a hostname for uniquely identifying the second mobile station.

21. The mobile station of claim 20, wherein execution of the programming by the processor to convert the mobile number assigned to the second mobile station configures the mobile station to perform functions including functions to:
remove punctuation from the mobile number assigned to the second mobile station;
reverse the order of digits in the mobile number having the punctuation removed;
insert one or more period separators between each grouping of digits in the mobile number having the order of digits reversed; and
append to the end of the mobile number having one or more period separators a domain name of a carrier associated with the second mobile station, to obtain the hostname for uniquely identifying the second mobile station.

22. The mobile station of claim 13, wherein:
the first mobile station has a packet address assigned thereto that is a private packet address that is unique to the first mobile station within a private address space; and
the packet address assigned to the second mobile station is a private packet address that is unique to the second mobile station within the private address space.

23. The mobile station of claim 13, wherein:
the packet address assigned to the second mobile station is a public packet address that uniquely identifies the second mobile station on the Internet.
